(19) United States
(12) Patent Application Publication
(10) Pub. No.: US 2003/0033739 A1
(43) Pub. Date: Feb. 20, 2003

(54) Safety lighting device

(76) Inventor: Norma H. Tingle, Fayetteville, NC (US)

Correspondence Address: Joseph N. Breaux, 10630 N. Oak Hills Pkwy., Suite A, Baton Rouge, LA, 70810, US

(21) Appl. No.: 09/727,001

(22) Filed: Nov. 29, 2000

(51) Int. Cl. G09F 13/04

(52) U.S. Cl. 40/564

(57) ABSTRACT

A safety lighting device holdable by a crossing guard or the like that includes an illumination source as well as an audible attention attracting device so as to increase the likelihood that a motorist will see the crossing guard in time to avoid an accident. The safety lighting device includes a sign housing; a rigid exterior handle portion; a rechargeable 9 Volt battery power supply; a red transparent plastic front sign plate having translucent white lettering provided thereon to indicate a desired message; interior light bulb and socket assemblies; a battery operated siren; a siren activation switch an exterior top light bulb and socket assembly mounted to a top exterior surface of the sign housing; and a light bulb activation switch mounted to the rigid exterior handle portion.

### TECHNICAL FIELD

The present invention relates to traffic safety equipment and more particularly to a safety lighting device for providing signals to children and vehicles at cross walks adjacent to schools and the like; the safety lighting device including a sign housing, a rigid exterior handle portion, a rechargeable 9 Volt battery power supply positioned within a bottom handle portion of the rigid exterior handle portion, a red transparent plastic front sign plate securable over an front opening of the sign housing and having translucent white lettering provided thereon to indicate a desired message such as “STOP”, two interior light bulb and socket assemblies attached to a housing interior handle portion in connection with the exterior rigid handle portion, a battery operated siren mounted within the rigid exterior handle portion, a siren activation switch secured to the rigid exterior handle portion and being in series electrical connection to form a circuit including the siren and the rechargeable 9 Volt battery power supply, an exterior top light bulb and socket assembly mounted to a top exterior surface of the sign housing, and a light bulb activation switch mounted to the rigid exterior handle portion; the light bulb activation switch being wired in series connection with the rechargeable battery power supply and in controlling electrical connection with the two interior light bulbs and the exterior top light bulb. The safety lighting device optionally including a removable telescoping bottom handle portion slidably attachable to a bottom portion of the exterior rigid handle portion and/or a safety sign stand portion; the safety sign stand portion including a base having a vertically oriented bottom handle portion receiving tube extending upwardly therefrom for receiving and holding the bottom handle portion in a manner to hold the safety lighting device in a vertical position.

### BACKGROUND ART

Each year many pedestrians are injured by cars while crossing at crosswalks near schools, playground, parks and other areas where large amounts of kids congregate. Placing a crossing guard in these locations can help, however, motorists often do not see the crossing guard in time to prevent an accident. It would be a benefit, therefore, to have a safety lighting device that could be held by a crossing guard or the like which included an illumination source as well as an audible attention attracting device so as to increase the likelihood that a motorist would see the crossing guard in time to avoid an accident.

### GENERAL SUMMARY DISCUSSION OF INVENTION

It is thus an object of the invention to provide a safety lighting device that includes a sign housing, a rigid exterior handle portion, a rechargeable 9 Volt battery power supply positioned within a bottom handle portion of the rigid exterior handle portion, a red transparent plastic front sign plate securable over an front opening of the sign housing and having translucent white lettering provided thereon to indicate a desired message such as “STOP”, two interior light bulb and socket assemblies attached to a housing interior handle portion in connection with the exterior rigid handle portion, a battery operated siren mounted within the rigid exterior handle portion, a siren activation switch secured to the rigid exterior handle portion and being in series electrical connection to form a circuit including the siren and the rechargeable 9 Volt battery power supply, an exterior top light bulb and socket assembly mounted to a top exterior surface of the sign housing, and a light bulb activation switch mounted to the rigid exterior handle portion; the light bulb activation switch being wired in series connection with the rechargeable battery power supply and in controlling electrical connection with the two interior light bulbs and the exterior top light bulb.

It is a further object of the invention to provide a safety lighting device that includes a removable telescoping bottom handle portion slidably attachable to a bottom portion of the exterior rigid handle portion.

It is a still further object of the invention to provide a safety lighting device that includes a base having a vertically oriented bottom handle portion receiving tube extending upwardly therefrom for receiving and holding the bottom handle portion in a manner to hold the safety lighting device in a vertical position.

It is a still further object of the invention to provide a safety lighting device that accomplishes all or some of the above objects in combination.

Accordingly, a safety lighting device is provided. The safety lighting device includes a sign housing, a rigid exterior handle portion, a rechargeable 9 Volt battery power supply positioned within a bottom handle portion of the rigid exterior handle portion, a red transparent plastic front sign plate securable over an front opening of the sign housing and having translucent white lettering provided thereon to indicate a desired message such as “STOP”, two interior light bulb and socket assemblies attached to a housing interior handle portion in connection with the exterior rigid handle portion, a battery operated siren mounted within the rigid exterior handle portion, a siren activation switch secured to the rigid exterior handle portion and being in series electrical connection to form a circuit including the siren and the rechargeable 9 Volt battery power supply, an exterior top light bulb and socket assembly mounted to a top exterior surface of the sign housing, and a light bulb activation switch mounted to the rigid exterior handle portion; the light bulb activation switch being wired in series connection with the rechargeable battery power supply and in controlling electrical connection with the two interior light bulbs and the exterior top light bulb.

The safety lighting device optionally including a removable telescoping bottom handle portion slidably attachable to a bottom portion of the exterior rigid handle portion and/or a safety sign stand portion. The bottom portion of the exterior rigid handle portion preferably is covered with green reflective material for greater visibility at a distance and under poor visibility conditions such as at night, early morning or in fog and/or rain. The safety sign stand portion preferably includes a base having a vertically oriented bottom handle portion receiving tube extending upwardly therefrom for receiving and holding the bottom handle portion in a manner to hold the safety lighting device in a vertical position.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 is an exploded perspective view of an exemplary embodiment of the safety lighting device of the present invention showing the sign housing, the optional removable telescoping bottom handle portion slidably attached to the bottom portion of the exterior rigid handle portion, the rechargeable 9 Volt battery power supply positioned within the bottom handle portion, the red transparent plastic front sign plate with translucent white lettering provided thereon removed to show the two interior light bulb and socket assemblies attached to a housing interior handle portion of the rigid handle portion positioned within the sign housing, the battery operated siren, the siren activation switch, the exterior top light bulb and socket assembly, and the light bulb activation switch.

FIG. 2 is a perspective view of the safety lighting device of FIG. 1 with the removable telescoping bottom handle portion removed from the bottom portion of the exterior rigid handle portion and the bottom portion of the exterior rigid handle portion positioned above the optional safety sign stand portion; the safety sign stand portion including a base having a vertically oriented bottom handle portion receiving tube extending upwardly therefrom.

### EXEMPLARY MODE FOR CARRYING OUT THE INVENTION

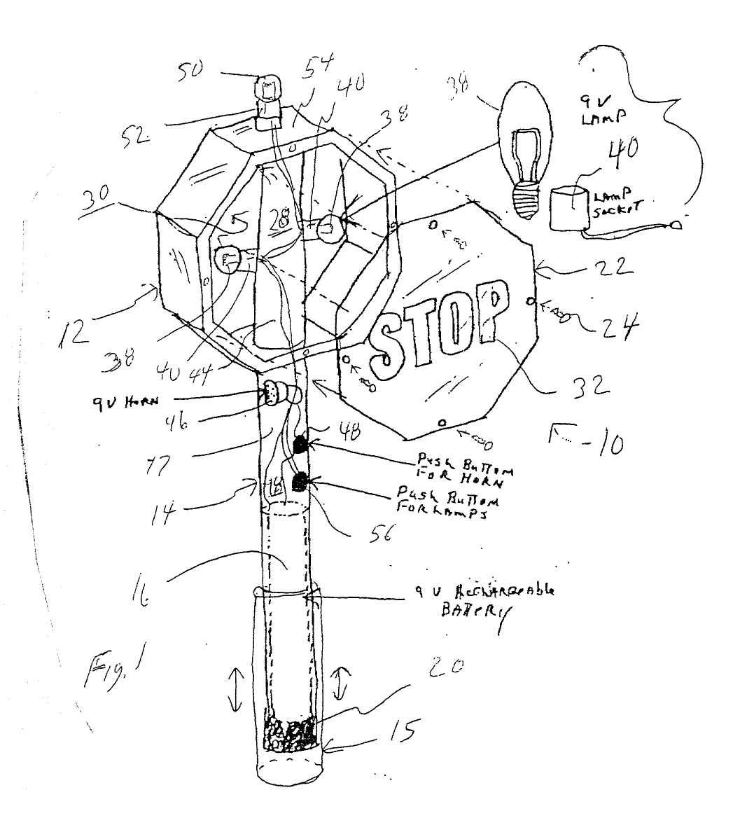

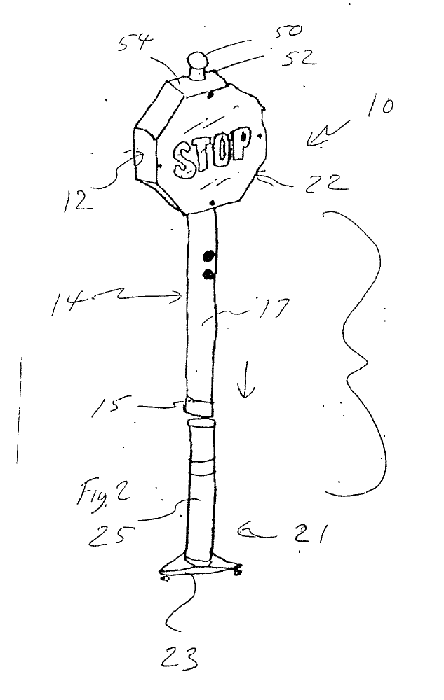

FIGS. 1 and 2 show various aspects of an exemplary embodiment of the safety lighting device of the present intention generally designated 10. Safety lighting device 10 includes a sign housing, generally designated 12; a rigid exterior handle portion, generally designated 14; a removable telescoping bottom handle portion, generally designated 15, slidably attachable to a bottom portion 20 of exterior rigid handle portion 14; a safety sign stand portion, generally designated 21, including a base 23 having a vertically oriented bottom handle portion receiving tube 25 extending upwardly therefrom for receiving and holding bottom handle portion 15 in a manner to hold safety lighting device 10 in a vertical position; a rechargeable 9 Volt battery power supply, generally designated 16, positioned within a cavity 18 of bottom handle portion 20 of rigid exterior handle portion 14 having a reflective green exterior surface 17; a red transparent plastic front sign plate, generally designated 22, securable with screws 24 over an front opening 28 into an internal light cavity 30 formed within sign housing 12 and having translucent white lettering 32 provided thereon to indicate a desired message such as “STOP”; two interior light bulbs 38 and two interior socket assemblies 40 attached to a housing interior handle portion 44 that passes through internal light cavity 30 and is in connection with exterior rigid handle portion 14; a battery operated siren 46 mounted in connection with rigid exterior handle portion 14; a siren activation switch 48 secured to rigid exterior handle portion 14 and being in series electrical connection with battery operated siren 46 and rechargeable 9 Volt battery power supply 16 such that, when siren activation switch 48 is in a closed state, battery operated siren 46 emits an audible alarm; an exterior top light bulb 50 and exterior top socket assembly 52 mounted to a top exterior surface 54 of sign housing 12; and a light bulb activation switch 56 mounted to rigid exterior handle portion 14.

Light bulb activation switch 14 is wired in series connection with rechargeable battery power supply 16 and in controlling electrical connection with the two interior light bulbs 38 and the exterior top light bulb 50 such that, when light bulb activation switch is in a closed state, the two interior light bulbs 38 and the exterior top light bulb 50 are illuminated. The two interior bulbs 38 illuminate the front sign plate 22 to make it extremely visibility even in dark, foggy, rainy and other poor visibility conditions.

It can be seen from the preceding description that a safety lighting device has been provided.

It is noted that the embodiment of the safety lighting device described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. A safety lighting device comprising:
a sign housing;
a rigid exterior handle portion;
a rechargeable 9 Volt battery power supply positioned within a bottom handle portion of the rigid exterior handle portion;
a red transparent plastic front sign plate securable over a front opening of the sign housing and having translucent white lettering provided thereon to indicate a desired message;
interior light bulb and socket assemblies attached to a housing interior handle portion in connection with the exterior rigid handle portion;
a battery operated siren mounted within the rigid exterior handle portion;
a siren activation switch secured to the rigid exterior handle portion and being in series electrical connection to form a circuit including the siren and the rechargeable 9 Volt battery power supply such that, when the siren activation switch is in a closed state, the battery operated siren emits an audible siren sound;
an exterior top light bulb and socket assembly mounted to a top exterior surface of the sign housing; and
a light bulb activation switch mounted to the rigid exterior handle portion;
the light bulb activation switch being wired in series connection with the rechargeable battery power supply and in controlling electrical connection with the interior light bulbs and the exterior top light bulb such that, when the light bulb activation switch is in a closed state, the interior light bulbs and the exterior top light bulb.

2. The safety lighting device of claim 1 further comprising:
a removable telescoping bottom handle portion slidably attachable to a bottom portion of the exterior rigid handle portion.

3. The safety lighting device of claim 1 further comprising:
a safety sign stand portion including a base having a vertically oriented bottom handle portion receiving tube extending upwardly therefrom for receiving and holding the bottom handle portion in a manner to hold the safety lighting device in a vertical position.

4. The safety lighting device of claim 1 wherein:
the exterior rigid handle portion has a reflective exterior surface.

5. The safety lighting device of claim 2 further comprising:
a safety sign stand portion including a base having a vertically oriented bottom handle portion receiving tube extending upwardly therefrom for receiving and holding the bottom handle portion in a manner to hold the safety lighting device in a vertical position.

6. The safety lighting device of claim 5 wherein:
the exterior rigid handle portion has a reflective exterior surface.

7. The safety lighting device of claim 2 wherein:
the exterior rigid handle portion has a reflective exterior surface.

8. The safety lighting device of claim 3 wherein:
the exterior rigid handle portion has a reflective exterior surface.
